(19) United States
(12) Patent Application Publication
(10) Pub. No.: US 2015/0378118 A1
(43) Pub. Date: Dec. 31, 2015

(54) HYBRID POWER AND OPTICAL FIBER CABLE WITH CONDUCTIVE BUFFER TUBE

(71) Applicants: Thomas P. HUEGERICH, Manchester Center, VT (US); Eric Ryan CHAPPELL, Statesville, NC (US); Wayne M. KACHMAR, North Bennington, VT (US)

(72) Inventors: Thomas P. HUEGERICH, Manchester Center, VT (US); Eric Ryan CHAPPELL, Statesville, NC (US); Wayne M. KACHMAR, North Bennington, VT (US)

(21) Appl. No.: 14/768,046

(22) PCT Filed: Feb. 12, 2014
(86) PCT No.: PCT/US14/15969

§ 371 Date: Aug. 14, 2015

Related U.S. Application Data
(60) Provisional application No. 61/765,997, filed on Feb. 18, 2013.
(60) Provisional application No. 61/766,001, filed on Feb. 18, 2013.

(51) Int. Cl. G02B 6/42; G02B 6/38; H01R 24/64; G02B 6/43; H01B 11/22; G02B 6/44; G02B 6/02

(52) U.S. Cl. CPC G02B 6/4293; G02B 6/4416; G02B 6/3817; G02B 6/443; G02B 6/02004; G02B 6/43; H01B 11/22; H01R 24/64; H01R 2107/00

(57) ABSTRACT

This disclosure is directed to a cable assembly including a cable with a first end and a second end. The cable includes first and second electrical conductors and first and second optical fibers. The cable assembly includes a first eight pin, eight contact modular connector mounted upon the first end and a second eight pin, eight contact modular connector mounted upon the second end. The first eight pin, eight contact modular connector and the second eight pin, eight contact modular connector each include an optical to electrical converter.

### CROSS REFERENCE TO RELATED APPLICATIONS

This application is being filed on 12 Feb. 2014, as a PCT International Patent application and claims priority to U.S. Patent Application Ser. No. 61/765,997 entitled “HYBRID POWER AND OPTICAL FIBER CABLE,” filed Feb. 18, 2013, and U.S. Patent Application Ser. No. 61/766,001 entitled “HYBRID POWER AND OPTICAL FIBER CABLE WITH CONDUCTIVE BUFFER TUBE,” filed Feb. 18, 2013, which are hereby incorporated by reference in their entirety.

### TECHNICAL FIELD

The present disclosure relates generally to hybrid optical fiber and electrical communication systems.

### BACKGROUND

Rapid growth of high-speed wireless devices including smart phones, tablets, and laptops continues in today's market, thereby creating higher demand for untethered contact. Today, copper solutions using RJ-45 plugs are most commonly used to connect high-speed wireless devices to a network, but have length and bandwidth limitations. Additionally, optical fiber solutions are costly and cumbersome, requiring external optical to electrical converters, several external power sources, and RJ-45 patch cords.

### SUMMARY

In general terms, this disclosure is directed to a hybrid power and optical fiber patch cord. In one possible configuration and by non-limiting example, the hybrid power and optical fiber cable is used to connect and power high speed wireless devices using optical fiber and electrical conductors in a single cable.

One aspect is a cable assembly comprising a cable with a first end and a second end, wherein the cable includes first and second electrical conductors and also includes first and second optical fibers. The cable assembly further comprises a first RJ-45 connector mounted upon the first end and a second RJ-45 connector mounted upon the second end wherein the first RJ-45 connector and the second RJ-45 connector each include an optical to electrical converter.

Another aspect is a patch cord comprises a hybrid cable having a first end and a second end, the hybrid cable including an outer jacket enclosing first and second electrical conductors that extend from the first end to the second end of the hybrid cable. The hybrid cable further includes first and second optical fibers that extend from the first end to the second end of the hybrid cable and that are enclosed within the outer jacket. The patch cord further comprises a first RJ-45 connector mounted at the first end of the hybrid cable and a second RJ-45 connector mounted at the second end of the hybrid cable, the first and second RJ-45 connectors each including a plurality of electrical contacts, the electrical contacts including power contacts and signal contacts, and the first and second RJ-45 connectors each including an optical to electrical converter. In addition, the optical to electrical converters are each electrically connected to the first and second electrical conductors and the first and second electrical conductors are also electrically connected to the power contacts of the first and second RJ-45 connectors. The optical to electrical converters further provide signal conversion interfaces between the first and second optical fibers and the signal contacts of the first and second RJ-45 connectors.

Another aspect is a system for providing high speed data transmission and power to an electronic device, wherein the system comprises a patch cord wherein the patch cord further comprises a hybrid cable, the hybrid cable including first and second electrical conductors and first and second optical fibers. The system further comprises a first RJ-45 connector mounted at a first end of the hybrid cable and a second RJ-45 connector mounted at a second end of the hybrid cable, the first and second RJ-45 connectors each including a plurality of electrical contacts, wherein the electrical contacts include power contacts and signal contacts, wherein the first and second RJ-45 connectors each include an optical to electrical converter electrically connected to the first and second electrical conductors. Additionally, the first and second electrical conductors are electrically connected to the power contacts of the first and second RJ-45 connectors and the optical to electrical converters provide signal conversion interfaces between the first and second optical fibers and the signal contacts of the first and second RJ-45 connectors. The system further comprises a first electronic device having a first RJ-45 jack, wherein the first RJ-45 jack has a plug opening for receiving the first RJ-45 connector of the patch cord, wherein the plug opening includes a plurality of electrical contacts, the plurality of electrical contacts including power contacts and signal contacts corresponding to the electrical and signal contacts of the first RJ-45 connector, wherein the first electronic device is powered by an external power source. The system also includes a second electronic device having a second RJ-45 jack, wherein the second RJ-45 jack has a plug opening for receiving the second RJ-45 connector of the patch cord, wherein the plug opening includes a plurality of electrical contacts, the plurality of electrical contacts including power contacts and signal contacts corresponding to the electrical and signal contacts of the second RJ-45 connector, wherein the second electronic device receives power from the first electronic device.

A further aspect is a cable assembly having a hybrid cable having a first end and a second end, the hybrid cable including an outer jacket enclosing first and second conductive buffer regions that extend from the first end to the second end of the hybrid cable, wherein the first conductive buffer region encloses a first optical fiber and the second conductive buffer region encloses a second optical fiber.

### BRIEF DESCRIPTION OF THE DRAWINGS

FIG. 1 shows a system diagram using a hybrid patch cord in accordance with the principles of the present disclosure.

FIG. 2 is a cross-sectional view of the hybrid cable shown in FIG. 1.

FIG. 3 is a cross-sectional view of an alternative embodiment of the hybrid cable shown in FIG. 1.

FIG. 4 is a cross-sectional view of an alternative embodiment of the hybrid cable shown in FIG. 1.

FIG. 5 is a cross-sectional view of an alternative embodiment of the hybrid cable shown in FIG. 1.

FIG. 6 is a perspective view of an RJ-45 plug mounted to a hybrid cable in accordance with the principles of the present disclosure.

FIG. 7 is a top plan view of an RJ-45 plug with an embedded optical to electrical converter in accordance with the principles of the present disclosure.

### DETAILED DESCRIPTION

Various embodiments will be described in detail with reference to the figures, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present disclosure describes a hybrid power and optical fiber patch cord using two modified eight pin, eight contact connector plugs and also includes optical fibers for data transmission and a buffer region with electrical conductors to power an external computing device. Additionally, the present disclosure describes an optical to electrical converter embedded within both eight pin, eight contact connector plugs, thereby eliminating the need for external optical to electrical converters. In some embodiments, an eight pin, eight contact connector plug is an RJ-45 plug. As used herein, the term RJ-45 plug means a plug having a standard RJ-45 plug interface including a rectangular form factor supporting eight consecutive electrical contacts, an alignment key, and a flexible latch for allowing matability with an RJ-45 jack.

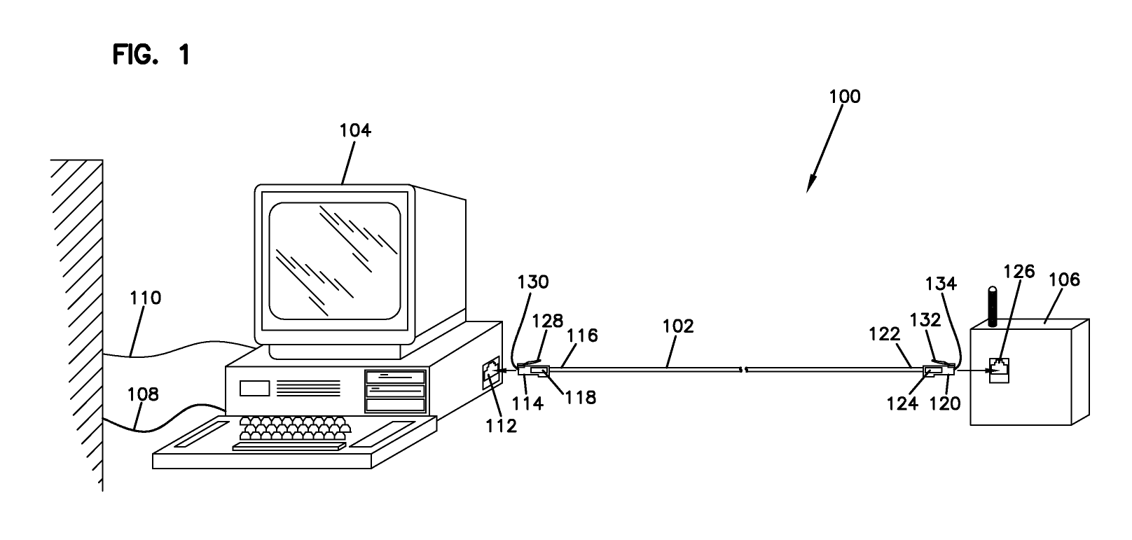

FIG. 1 is a perspective view of a system 100 using a hybrid cable 102. In this example embodiment, the system 100 includes a hybrid cable 102 connecting a first electronic device 104 to a second electronic device 106. In this example, the first electronic device 104 is a desktop computer containing an internal AC-DC power supply (not shown) that is powered by a wall outlet (not shown) using a power cable 108. In other embodiments, the first or second electronic devices 104 and 106, respectively can be a computing device. An example of a computing device is a voice over Internet Protocol phone, a camera, a mobile computing device, or a desktop computing device. An example of a desktop computing device is a personal computer or a network configured television. An example of a mobile computing device is a smartphone, a laptop computer, a personal digital assistant, a tablet computer, and the like. In other embodiments, the second electronic device 106 is a metrocell, an antenna, or a distributed antenna system. The first electronic device 104 receives data through an Ethernet port in a wall outlet (not shown) using an Ethernet cable 110 or any other cable suitable for data transmission. The first electronic device also includes an RJ-45 jack 112, or a plug opening including a plurality of electrical contacts wherein the contacts further include a plurality of signal contacts and power contacts corresponding to the electrical and signal contacts of a mating RJ-45 plug 114. The RJ-45 jack 112 is used to send and receive data to and from the second electronic device 106 and to send power (e.g., DC power) to the second electronic device 106 over the hybrid cable 102. In one example, the power provided through the hybrid cable 102 ranges from 15 to 50 watts.

In this example, the hybrid cable 102 connects to the RJ-45 jack 112 of the first electronic device 104 using the first RJ-45 plug 114 mounted to the first end 116 of the hybrid cable 102. The RJ-45 plug 114 also contains a latch 128 and an alignment key 130 for allowing matability with the RJ-45 jack 112. The RJ-45 plug 114 also includes an embedded optical to electrical converter 118 used to convert electrical signals received from the first electronic device 104 to optical signals and to convert optical signals received from the hybrid cable 102 to electrical signals transmitted to the first electronic device 104.

In this example, the second electronic device 106 is a wireless router and also contains an RJ-45 jack 126, or a plug opening including a plurality of electrical contacts wherein the contacts further include a plurality of signal contacts and power contacts corresponding to the electrical and signal contacts of the mating RJ-45 plug 120. The RJ-45 jack 126 is used to send and receive data to and from the first electronic device 104 and to receive power from the first electronic device 104 over the hybrid cable 102.

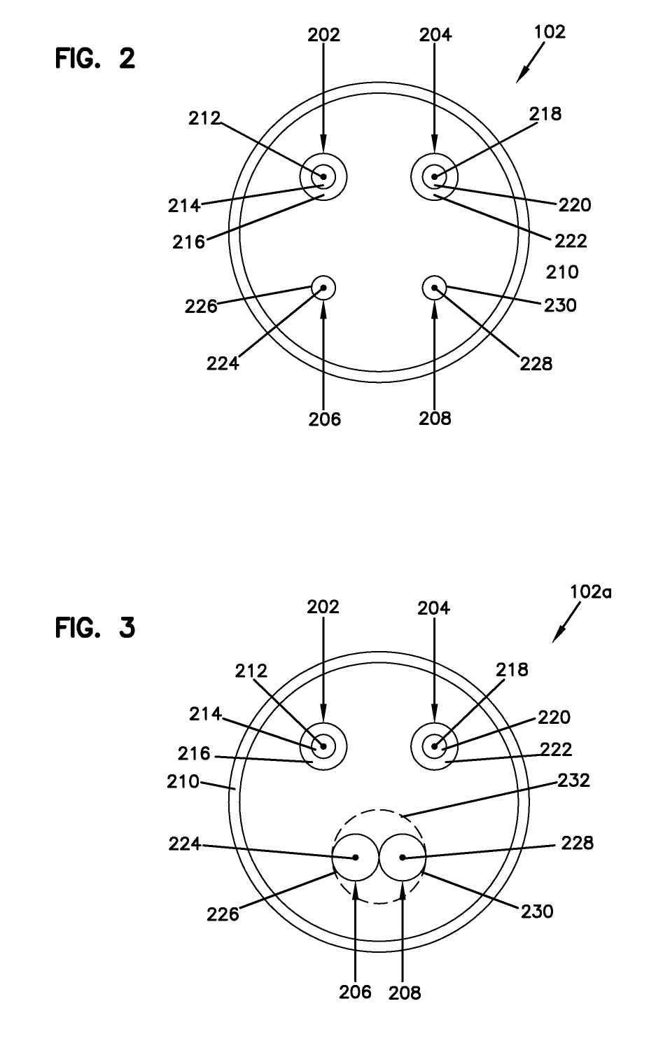

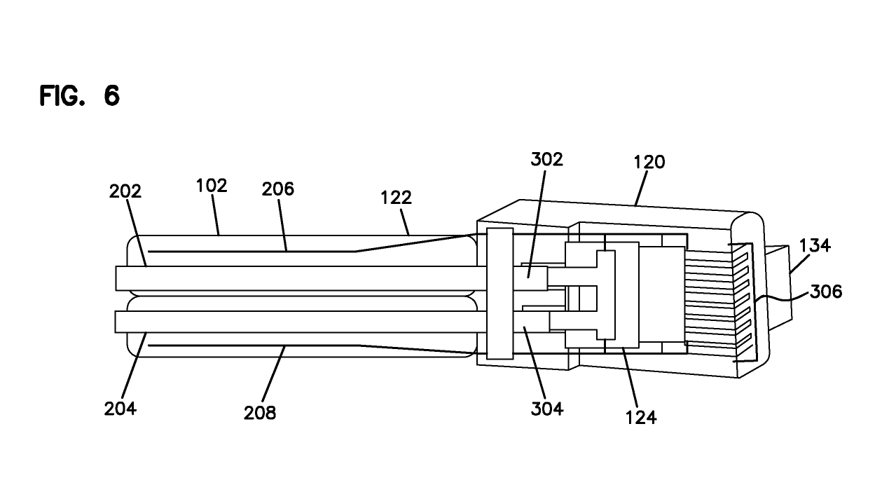

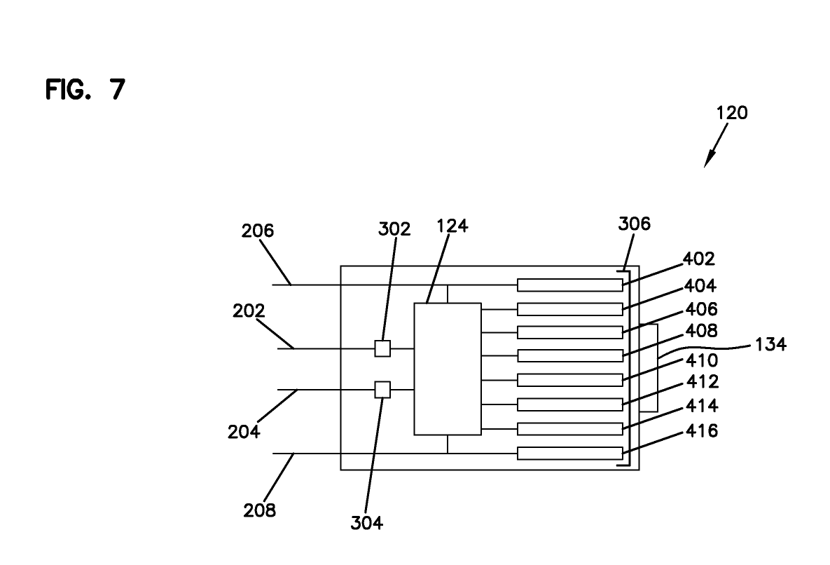

In this example, the hybrid cable 102 connects to the RJ-45 jack 126 of the second electronic device 106 using a second RJ-45 plug 120 mounted to the second end 122 of the hybrid cable 102. The RJ-45 plug 120 also contains a latch 132 and an alignment key 134 for allowing matability with the RJ-45 jack 126. The RJ-45 plug 120 also includes an embedded optical to electrical converter 124 used to convert electrical signals received from the second electronic device 106 to optical signals and to convert optical signals received from the hybrid cable 102 to electrical signals transmitted to the second electronic device 106. The hybrid cable 102 is discussed in more detail with reference to FIGS. 2-7. The RJ-45 plugs 114 and 120 are discussed in more detail with reference to FIGS. 6-7.

FIG. 2 is a cross-sectional view of the hybrid cable 102 shown in FIG. 1. In this embodiment, the hybrid cable 102 contains first and second optical fibers 202 and 204, respectively, and first and second electrical conductors 206 and 208, respectively, housed in an insulating outer jacket 210.

As shown in this embodiment, the first optical fiber 202 includes a core region 212 that is surrounded by a cladding region 214 and an outer coating region 216. The second optical fiber 204 is substantially similar to the first optical fiber 202 and also has a core region 218 surrounded by a cladding region 220 and an outer coating region 222. In some embodiments, the core region 212 and 218 of a single-mode optical fiber has a diameter in the range of about 8 micrometers to about 10 micrometers. In other embodiments, the cladding region 214 and 220 of a single-mode optical fiber has a diameter in the range of about 120 micrometers to about 130 micrometers. In yet other embodiments, the coating region 216 and 222 of a single-mode optical fiber has a diameter in the range of about 190 micrometers to about 260 micrometers. In some embodiments, the first and second optical fibers 202 and 204, respectively, are single-mode and have dimensions as described above. In other embodiments, the optical fibers 202, 204 are multi-mode fibers. In some embodiments, the core region 212 and 218 of a multi-mode optical fiber has a diameter in the range of about 50 micrometers to about 100 micrometers. In other embodiments, the cladding region 214 and 220 of a multi-mode optical fiber has a diameter in the range of about 120 micrometers to about 140 micrometers. In yet other embodiments, the coating region 216 and 222 of a multi-mode optical fiber has a diameter in the range of about 235 micrometers to about 260 micrometers.

As shown in this embodiment, the first electrical conductor 206 includes a conductive core 224 and an insulating layer 226. The second electrical conductor 208 also contains a conductive core 228 and an insulating layer 230. In some embodiments, additional insulating layers are used. In some embodiments, the first electrical conductor 206 is used to deliver power from the first electronic device 104 to the second electronic device 106 over the hybrid cable 102 while the second electrical conductor 208 is used for ground. Types of conductive materials that are used are copper or aluminum. In other embodiments, other types of conductive materials are used. In other embodiments, the hybrid cable 102 includes reinforcing structures such as aramid yarn, fiber reinforced polymeric (e.g., epoxy) rods, or other structures.

FIG. 3 is a cross-sectional view of an alternative hybrid cable 102a suitable for use in the system of FIG. 1. In this embodiment, the hybrid cable 102a includes first and second optical fibers 202 and 204, respectively. The hybrid cable 102a also includes first and second electrical conductors 206 and 208, respectively, arranged in a twisted pair 232 configuration.

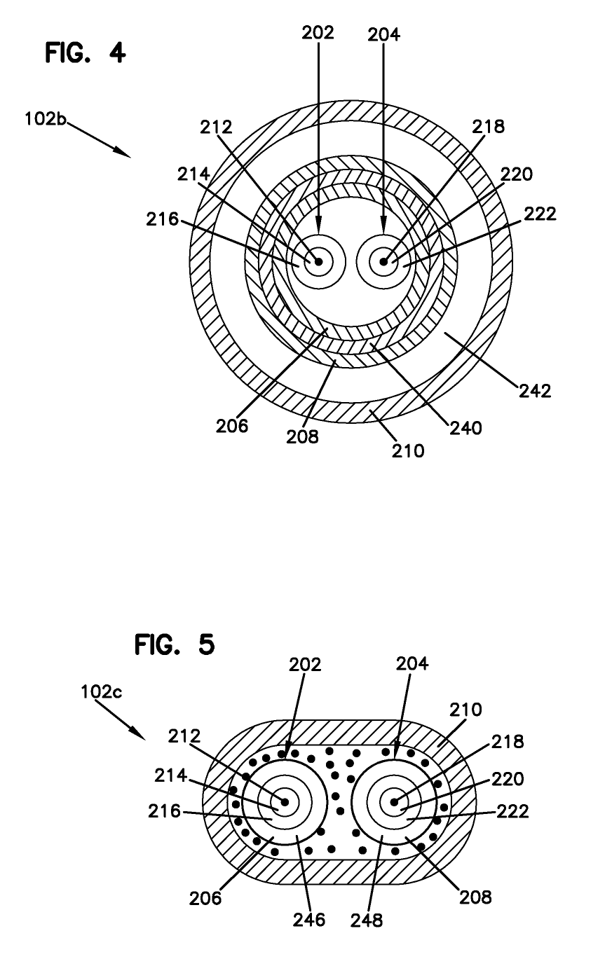

FIG. 4 is a cross-sectional view of an alternative hybrid cable 102b suitable for use in the system of FIG. 1. In this embodiment, the first and second optical fibers 202 and 204, respectively, are enclosed within the first and second electrical conductors 206 and 208, respectively, and housed within the outer jacket 210. The first optical fiber 202 includes a core region 212 that is surrounded by a cladding region 214 and an outer coating region 216. The second optical fiber 204 is substantially similar to the first optical fiber 202 and also has a core region 218 surrounded by a cladding region 220 and an outer coating region 222. In this embodiment, the first and second optical fibers 202 and 204, respectively, are surrounded by the first electrical conductor 206, and the first electrical conductor 206 is further surrounded by a reinforcing, insulating layer 240 (e.g., tensile reinforcing tape, such as aramid yarn tape). The reinforcing, insulating layer 240 is further surrounded by the second electrical conductor 208, which is surrounded by a region of air 242 and housed within the outer jacket 210.

FIG. 5 is a cross-sectional view of an alternative the hybrid cable 102c shown in FIG. 1. In this embodiment, the hybrid cable 102c contains first and second optical fibers 202 and 204, respectively, surrounded by first and second conductive buffer regions 246 and 248, respectively, housed in an insulating outer jacket 210.

In this embodiment, the first optical fiber 202 includes a core region 212 that is surrounded by a cladding region 214 and an outer coating region 216. The first optical fiber 202 further includes a first conductive buffer region 246 that is comprised of polymeric material with integrated conductive material so that the first conductive buffer region 246 is conductive and acts as the first electrical conductor 206. In this embodiment, as the first electrical conductor 206, the first conductive buffer region 246 carries power across the hybrid cable 102c.

The second optical fiber 204 is substantially similar to the first optical fiber 202 and also has a core region 218 surrounded by a cladding region 220 and an outer coating region 222. The second optical fiber 204 further includes a second conductive buffer region 248 that is comprised of polymeric material with integrated conductive material so that the second conductive buffer region 248 is conductive and acts as the second electrical conductor 208. In this embodiment, as the second electrical conductor 208, the second conductive buffer region 248 is the ground conductor within the hybrid cable 102c.

In some embodiments, the core region 212 and 218 of a single-mode optical fiber has a diameter in the range of about 8 micrometers to about 10 micrometers. In other embodiments, the cladding region 214 and 220 of a single-mode optical fiber has a diameter in the range of about 120 micrometers to about 130 micrometers. In yet other embodiments, the coating region 216 and 222 of a single-mode optical fiber has a diameter in the range of about 190 micrometers to about 260 micrometers. In some embodiments, the first and second optical fibers 202 and 204, respectively, are single-mode and have dimensions as described above. In other embodiments, the optical fibers 202, 204 are multi-mode fibers. In some embodiments, the core region 212 and 218 of a multi-mode optical fiber has a diameter in the range of about 50 micrometers to about 100 micrometers. In other embodiments, the cladding region 214 and 220 of a multi-mode optical fiber has a diameter in the range of about 120 micrometers to about 140 micrometers. In yet other embodiments, the coating region 216 and 222 of a multi-mode optical fiber has a diameter in the range of about 235 micrometers to about 260 micrometers.

In some embodiments, the first electrical conductor 206 within the first conductive buffer region 246 is used to deliver power from the first electronic device 104 to the second electronic device 106 over the hybrid cable 102c while the second electrical conductor 208 within the second conductive buffer region 248 is used for ground. Types of conductive materials that are used are copper or aluminum. In other embodiments, other types of conductive materials are used. In other embodiments, the hybrid cable 102c includes reinforcing structures such as aramid yarn, fiber reinforced polymeric (e.g., epoxy) rods, or other structures.

FIG. 6 is a perspective view of the second RJ-45 plug 120 mounted to the second end 122 of the hybrid cable 102. The hybrid cable 102 includes the first and second optical fibers 202 and 204, respectively. Additionally, the hybrid cable 102 contains the electrical conductor 206 used for power and the electrical conductor 208 used for ground that terminate at power contacts of the RJ-45 plug 120. As described above, the electrical conductors 206 and 208 are used to power the second electronic device 106 and the optical to electrical converter 124, using power from the internal AC-DC power supply in the first electronic device 104.

Both optical fibers 202 and 204 are connected to the optical to electrical converter 124, embedded within the RJ-45 plug 120, using first and second splices 302 and 304, respectively. The splices can be fusion splices or mechanical splices. Example mechanical splices that can be used are found in PCT/EP2013/052345, the disclosure of which is hereby incorporated by reference.

The optical to electrical converter 124 is a small form factor pluggable transceiver embedded within the RJ-45 plug 120 and is powered by the electrical conductors 206 and 208. The optical to electrical converter 124 converts and splits the optical signals from the optical fibers 202 and 204 into a plurality of electrical signals that are then distributed across a plurality of signal contacts among a plurality of electrical contacts 306 of the RJ-45 plug 120. The optical to electrical converter 124 also converts the electrical signals received from the second electronic device 106, which are distributed across the plurality of electrical contacts 306, to optical signals and splits those optical signals which are then distributed across the first and second optical fibers 202 and 204, respectively. The optical to electrical converter 124 is discussed in more detail with reference to FIG. 7.

FIG. 7 is a top plan view of the RJ-45 plug 120 with the embedded optical to electrical converter 124. In some embodiments a vertical cavity surface emitting laser is used as to transmit the optical signal over the optical fibers 202 and 204. In other embodiments, a Fabry-Perot laser diode is used to transmit the optical signal over the optical fibers 202 and 204.

In this embodiment, the RJ-45 plug 120 includes first and second splices 302 and 304, respectively. The RJ-45 plug 120 includes eight consecutively arranged first, second, third, fourth, fifth, sixth, seventh, and eighth electrical contacts 402, 404, 406, 408, 410, 412, 414, and 416, respectively, that are electrically connected to the output of the optical to electrical converter 124 and the first and second electrical conductors 206 and 208, respectively.

In some embodiments, contacts 402 and 416 are power contacts and are electrically connected to electrical conductors 206 and 208. In higher power embodiments, contacts 404 and 414 are also used as power contacts in addition to 402 and 416. In some embodiments, contacts 406, 408, 410, and 412 are signal contacts and are electrically connected to the electrical input/output of the optical to electrical converter 124. In yet other embodiments, the first optical fiber 202 is electrically connected to the fourth and fifth electrical contacts 408 and 410, respectively, while the second optical fiber 204 is electrically connected to the third and sixth electrical contacts 406 and 412, respectively.

The first RJ-45 plug 114 is substantially similar to the second RJ-45 plug 120 and also includes first and second splices, an optical to electrical converter 118, and a plurality of electrical contacts as described herein. The first RJ-45 plug 114 also includes similar connectivity features as the second RJ-45 plug 120.

Aspects of this disclosure specifically reference the use of RJ-45 connectors, however the system described in the present disclosure can be implemented using other connectors having a form factor consistent with an RJ-45 connector. Examples of other suitable connectors are found within the family of standardized IEC 60603-7 eight pin, eight contact modular connectors.

The various embodiments described above are provided by way of illustration only and should not be construed to limit the overall intention aspects disclosed herein. Those skilled in the art will readily recognize various modifications and changes that may be made without following the example embodiments and applications illustrated and described herein, and without departing from the true spirit and scope of the invention aspects disclosed herein.

1. A cable assembly, comprising:
a cable with a first end and a second end, wherein the cable includes first and second electrical conductors, the cable also includes first and second optical fibers; and
a first eight pin, eight contact modular connector mounted upon the first end and a second eight pin, eight contact modular connector mounted upon the second end wherein the first eight pin, eight contact modular connector and the second eight pin, eight contact modular connector each include an optical to electrical converter.

2. The cable assembly of claim 1, wherein the first and second eight pin, eight contact modular connectors are of type RJ-45.

3. The cable assembly of claim 1, wherein the first and second optical fibers are single-mode or multi-mode.

4. The cable assembly of claim 1, wherein the first electrical conductor is a power line and the second electrical conductor is a ground line.

5. The cable assembly of claim 4, wherein the power line and the ground line are connected to pins 1 and 8 of the first and second eight pin, eight contact modular connector.

6. The cable assembly of claim 5, wherein the power line and the ground line are further connected to pins 2 and 7 of the first and second eight pin, eight contact modular connector.

7. The cable assembly of claim 4, wherein the power line powers a device connected to the second eight pin, eight contact modular connector.

8. The cable assembly of claim 1, wherein the first and second electrical conductors are a twisted pair of electrical conductors.

9. The cable assembly of claim 1, wherein the electrical conductors further comprise at least one copper cable.

10. The cable assembly of claim 3, wherein the first and second optical fibers further comprise a core region surrounded by a cladding region, a coating region, and an outer jacket.

11. The cable assembly of claim 10, wherein the core region of the single-mode fiber has a diameter in the range of about 8-10 micrometers.

12. The cable assembly of claim 10, wherein the cladding region of the single-mode fiber has a diameter in the range of about 120-130 micrometers.

13. The cable assembly of claim 10, wherein the coating region of the single-mode fiber has a diameter in the range of about 190-260 micrometers.

14. The cable assembly of claim 10, wherein the core region of the multi-mode fiber has a diameter in the range of about 50-100 micrometers.

15. The cable assembly of claim 10, wherein the cladding region of the multi-mode fiber has a diameter in the range of about 120-140 micrometers.

16. The cable assembly of claim 10, wherein the coating region of the multi-mode fiber has a diameter in the range of about 235-260 micrometers.

17. A patch cord comprising:
a hybrid cable having a first end and a second end, the hybrid cable including an outer jacket enclosing first and second electrical conductors that extend from the first end to the second end of the hybrid cable, the hybrid cable also including first and second optical fibers that extend from the first end to the second end of the hybrid cable and that are enclosed within the outer jacket; and
a first eight pin, eight contact modular connector mounted at the first end of the hybrid cable and a second eight pin, eight contact modular connector mounted at the second end of the hybrid cable, the first and second eight pin, eight contact modular connectors each including a plurality of electrical contacts, the electrical contacts including power contacts and signal contacts, and the first and second eight pin, eight contact modular connectors each including an optical to electrical converter;
the optical to electrical converters each being electrically connected to the first and second electrical conductors;
the first and second electrical conductors being electrically connected to the power contacts of the first and second eight pin, eight contact modular connectors; and
the optical to electrical converters providing signal conversion interfaces between the first and second optical fibers and the signal contacts of the first and second eight pin, eight contact modular connectors.

18. The patch cord of claim 17, wherein the electrical contacts of the first and second eight pin, eight contact connectors include consecutively arranged first, second, third, fourth, fifth, sixth, seventh and eighth electrical contacts, wherein the power contacts include the first and eighth electrical contacts, and wherein the signal contacts include the third, fourth, fifth, and sixth electrical contacts.

19. The patch cord of claim 17, wherein the first optical fiber is coupled to the fourth and fifth electrical contacts and the second optical fiber is coupled to the third and sixth electrical contacts.

20. The patch cord of claim 17, wherein the first and second eight pin, eight contact modular connectors are of type RJ-45.

21. A system for providing high speed data transmission and power to an electronic device, the system comprising:
a patch cord wherein the patch cord further comprises a hybrid cable, the hybrid cable including first and second electrical conductors and first and second optical fibers;
a first eight pin, eight contact modular connector mounted at a first end of the hybrid cable and a second eight pin, eight contact modular connector mounted at a second end of the hybrid cable, the first and second eight pin, eight contact modular connectors each including a plurality of electrical contacts, the electrical contacts including power contacts and signal contacts, and the first and second eight pin, eight contact modular connectors each including an optical to electrical converter electrically connected to the first and second electrical conductors;
the first and second electrical conductors being electrically connected to the power contacts of the first and second eight pin, eight contact modular connectors;
the optical to electrical converters providing signal conversion interfaces between the first and second optical fibers and the signal contacts of the first and second eight pin, eight contact modular connectors;
a first electronic device having a first eight pin, eight contact jack, wherein the first eight pin, eight contact jack has a plug opening for receiving the first eight pin, eight contact modular connector of the patch cord, wherein the plug opening includes a plurality of electrical contacts, the plurality of electrical contacts including power contacts and signal contacts corresponding to the electrical and signal contacts of the first eight pin, eight contact modular connector, wherein the first electronic device is powered by an external power source; and
a second electronic device having a second eight pin, eight contact jack, wherein the second eight pin, eight contact jack has a plug opening for receiving the second eight pin, eight contact modular connector of the patch cord, wherein the plug opening includes a plurality of electrical contacts, the plurality of electrical contacts including power contacts and signal contacts corresponding to the electrical and signal contacts of the second eight pin, eight contact modular connector, wherein the second electronic device receives power from the first electronic device.

22. The system of claim 21, wherein the first electronic device is a computing device.

23. The system of claim 21, wherein the second electronic device is a computing device.

24. The system of claim 21, wherein the first and second eight pin, eight contact modular connectors are of type RJ-45.

25.-37. (canceled)
